(19) United States
(12) Patent Application Publication
(10) Pub. No.: US 2023/0324946 A1
(43) Pub. Date: Oct. 12, 2023

(54) LIFTING MACHINE, SUCH AS AN AERIAL LIFT, FOR LIFTING PERSONS AND OPTIONALLY LOADS

(71) Applicant: MANITOU BF, ANCENIS (FR)

(72) Inventor: Jérôme ROUSSEAU, ANCENIS (FR)

(21) Appl. No.: 18/044,500

(22) PCT Filed: Sep. 6, 2021
(86) PCT No.: PCT/FR2021/051522

§ 371 Date: Mar. 8, 2023

(30) Foreign Application Priority Data
Sep. 11, 2020 (FR) FR2009203

(51) Int. Cl. G05G 9/047; B66F 11/04

(52) U.S. Cl. CPC G05G 9/04788; B66F 11/042

(57) ABSTRACT

Disclosed is a lifting machine (I) comprising a work platform (2), a mechanism (6) for lifting the work platform (2), and a control console (7) for controlling at least the lifting mechanism (6), the work platform (2) comprising a floor (3) and a guardrail (4) forming the longitudinal (41) and transverse (42) walls of an enclosure surrounding at least a part of the floor (3), the guardrail (4) comprising at least one top rail (5), referred to as a handrail, and the control console (7) comprising an attachment device (8) for removably coupling the control console (7) to the top rail (5). The top rail (5) is a rail with non-circular cross-section, and the control console (7) can be coupled to the top rail (5) by snap-fastening.

The present invention relates to a lifting machine, such as an aerial lift, for lifting a person and possibly a load and a method for coupling a control console of the lifting mechanism of said machine to the top rail of a guard rail of such a machine.

It relates in particular to a lifting machine comprising a work platform, a lifting mechanism for raising said work platform, and a control console for controlling at least the lifting mechanism, said work platform comprising a floor and a guard rail forming the longitudinal and transverse walls of an enclosure surrounding at least a part of said floor, said guard rail comprising at least a top rail, called hand rail, of non-circular section, this top rail having a top face and a bottom face and the control console comprising a fixing device to allow the control console to be removably coupled to the top rail and the control console comprising a fixing device to allow the control console to be removably coupled to at least the top rail.

The lifting machines, in particular the aerial lifts, require, for their operation, notably for controlling the lifting mechanism and, possibly, controlling the progress of the machine, a control console. Hitherto, a space has, on the lifting machine, been dedicated to receiving said control console, including when the control console is removably mounted on the work platform. Moreover, the removable coupling solutions as described for example in the patent FR 3 050 193 or FR 3 091 524 are not reliable.

At the same time, the manufacturers of lifting machines are constantly seeking solutions that make it possible to improve the working conditions of the operative.

One aim of the invention is to propose a lifting machine whose design makes it possible to improve the working conditions of the operative while offering a secure coupling of the control console to the guard rail of the machine.

To this end, the subject of the invention is a lifting machine comprising a work platform, a lifting mechanism for raising said work platform, and a control console for controlling at least the lifting mechanism, said work platform comprising a floor and a guard rail forming the longitudinal and transverse walls of an enclosure surrounding at least a part of said floor, said guard rail comprising at least one top rail, called hand rail, of non-circular section, this top rail having a top face and a bottom face and the control console comprising a fixing device to allow the control console to be removably coupled to the top rail, characterized in that the control console can be coupled to the top rail by snap-fitting, in that the fixing device of the control console comprises, for the control console to be coupled to the top rail by snap-fitting, one or more fixing members that are at least partially elastically deformable, and in that the control console has at least one so-called bearing surface, that is able to come into bearing contact with the top rail when the control console is coupled to the top rail, at least a part of the bearing surface and at least a part of the or of at least one of the fixing members defining between them a housing for the top rail having a passage for insertion of the top rail into said housing, this passage being configured to, by elastic deformation of at least a part of the or of at least one of the fixing members, widen upon the introduction of the top rail into said housing before closing up again beyond a predetermined position of introduction of the top rail into said housing. The control console can be coupled by elastic snap-fitting, also called simply snap-fitting, to the top rail. The terms snap-fitting and elastic snap-fitting will therefore be used without distinction to designate the same mode of assembly. This snap-fitting or elastic snap-fitting is synonymous with the expression elastic fitting. This snap-fitting is a mode of assembly, that is to say interlocking, in which at least one element is deformed upon introduction. By virtue of the fact that the control console can be coupled by snap-fitting, also called elastic snap-fitting, that is to say by elastic deformation of at least a part of the fixing device, to the top rail, the result thereof is that it is possible to simply and rapidly fix the control console in any position on the top rail depending on the desired working conditions. Such fixing by snap-fitting also makes it possible to easily reposition the control console. The production of the top rail with a non-circular, and preferably quadrangular, cross-section makes it possible, simply, to avoid a rotation of the control console about the top rail. A coupling by snap-fitting also makes it possible to avoid an accidental uncoupling of the control console from the top rail.

According to one embodiment of the invention, the so-called bearing surface, able to come into bearing contact with the top rail when the control console is coupled to the top rail, is a surface, preferably rigid, configured to come at least into bearing contact with the bottom face of the top rail. This provision simply allows assembly with locked fitting. This assembly is particularly secure when the bearing surface is a rigid surface with a rigidity greater than the fixing members. Thus, this bearing surface forms an anti-lifting abutment and a more complex movement is needed to obtain an uncoupling of the control console from the top rail.

According to one embodiment of the invention, the or at least one of the at least partially elastically deformable fixing members of the fixing device for fixing the control console to the top rail caps the top rail on the top, when the control console is coupled to the top rail. The result thereof is simplicity of implementation.

According to one embodiment of the invention, the or at least one of the fixing members which, when the control console is coupled to the top rail, caps the top rail on the top, is a U-shaped spring clamp that is open toward the floor and at least a part of the or of at least one of the bearing surfaces of the control console is disposed facing the web of the U to delimit, with the U, the housing for receiving the top rail. The U comprises a web and two branches. Preferably, the bearing surface is integral to one of the branches of the U. Once again, this provision allows simple assembly with locked fitting.

According to one embodiment of the invention, the housing is of generally quadrangular section and the passage for insertion of the top rail into said housing is formed in one of the corners of said housing, preferably between at least a part of the bearing surface and an end of one of the branches of the U.

According to one embodiment of the invention, when the control console is coupled to the top rail, the part of the bearing surface of the control console, in bearing contact with the bottom face of the top rail, extends in a plane that is transverse, preferably orthogonal, to the plane passing through one of the branches of the U and at a distance from the web of the U according to the distance between the top and bottom faces of the top rail to sandwich the top and bottom faces of the top rail between said bearing surface of the control console and the web of the U. Thus, any risk of accidental dismantling and pivoting displacement about a rail of the guard rail of the control console is avoided.

According to one embodiment of the invention, when the control console is coupled to the top rail, at least a part of the control console extends at least partially overhanging the guard rail to generate, under the effect of the weight of said overhanging part of the control console, a tilting torque of the control console, bringing the bearing surface of the control console closer to the bottom face of the top rail with which the bearing surface of the control console can come into bearing contact. Once again, this provision makes it possible to reinforce the mechanical strength of the mounting by snap-fitting.

According to one embodiment of the invention, the control console comprises at least one control member and two side plates between which the or at least one of the control members extends and at least one of the fixing members of the fixing device protrudes at least partially from one of the side plates outward from the control console, that is to say protruding from the outer face of the side plate, the outer face corresponding to the face of the side plate opposite the so-called inner face of the side plate turned toward the other side plate. The interior of the control console corresponds to the space between the side plates.

According to one embodiment of the invention, the fixing device comprising several fixing members, at least one of the fixing members of the fixing device protrudes at least partially from one of the side plates outward from the control console and at least the other or one other of the fixing members of the fixing device protrudes at least partially from the other of the side plates outward from the control console, the control console has distinct positions of coupling to the top rail, and the fixing members are members that can be selectively activated according to the selected coupling position. The control console has distinct positions of coupling to the top rail. The multiplying of the coupling positions offers the operative the opportunity to have a comfortable position for each control action to be performed. The control console is configured to move from one coupling position to another without tools. This provision allows a rapid change from one coupling position to another. One of the positions of coupling of the control console can be a position in which the control console extends at least partially toward the interior of the enclosure delimited by the guard rail. One of the positions of coupling of the control console can be a position in which the control console extends at least partially outward from the enclosure delimited by the guard rail. The operative can thus have a maximal space inside the enclosure when the control console extends at least partially outward from the enclosure. The positions of coupling of the control console can correspond, for one, to a position in which the control console is coupled to one of the longitudinal, or respectively transverse, walls of the enclosure and, for the other, to a position in which the control console is coupled to the opposite longitudinal, or respectively transverse, wall of said enclosure. By virtue of this design, the control console can without distinction be used by a right-handed person or a left-handed person. At least one of the fixing members, ideally each of the fixing members, is a multipurpose fixing member configured to be active, on the one hand, both when the control console is positioned at least partially inside the enclosure and when the control console is positioned at least partially outside the enclosure, on the other hand, both when the control console is coupled to one of the longitudinal or respectively transverse walls of the enclosure and when the control console is coupled to the other of the longitudinal or respectively transverse walls of the enclosure.

According to one embodiment of the invention, at least one of the side plates is provided with a so-called lateral gripping handle produced in a single piece with said side plate and the control console comprises a central handle disposed between the side plates and coupled to each of the side plates.

Another subject of the invention is a method for coupling, to the top rail of a guard rail of a lifting machine, a control console used to control at least the lifting mechanism of said lifting machine, characterized in that, said lifting machine conforming to that described above, the method comprises a step of introduction of the top rail into the insertion passage of the housing defined by at least a part of the bearing surface and at least a part of the or of at least one of the fixing members during which the or at least one of the elastically deformable fixing members is deformed in the direction of a widening of said passage and a step of continuation of the introduction to a predetermined position of introduction of the top rail into said housing in which said passage closes up again.

### BRIEF DESCRIPTION OF THE DRAWINGS

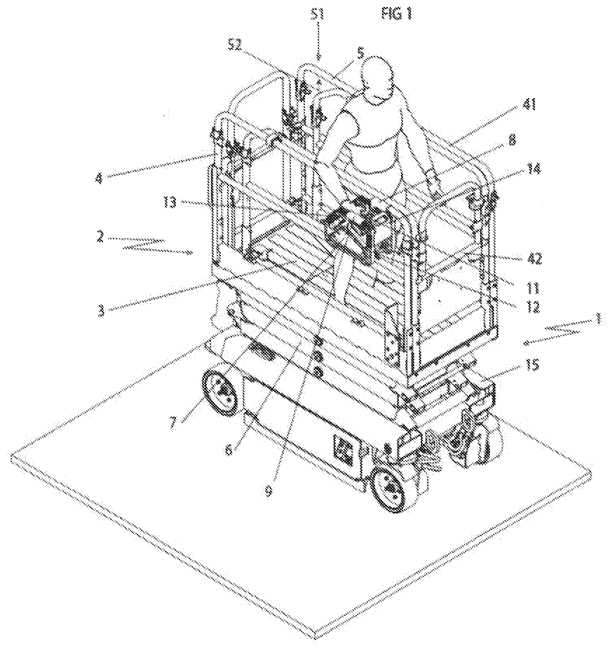

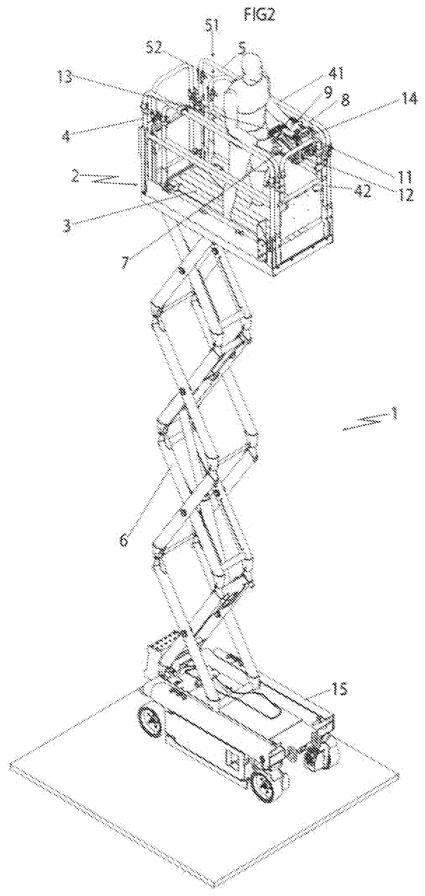

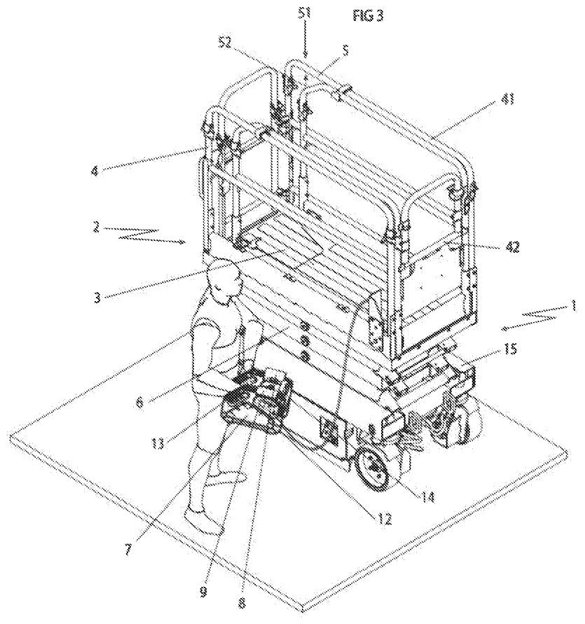

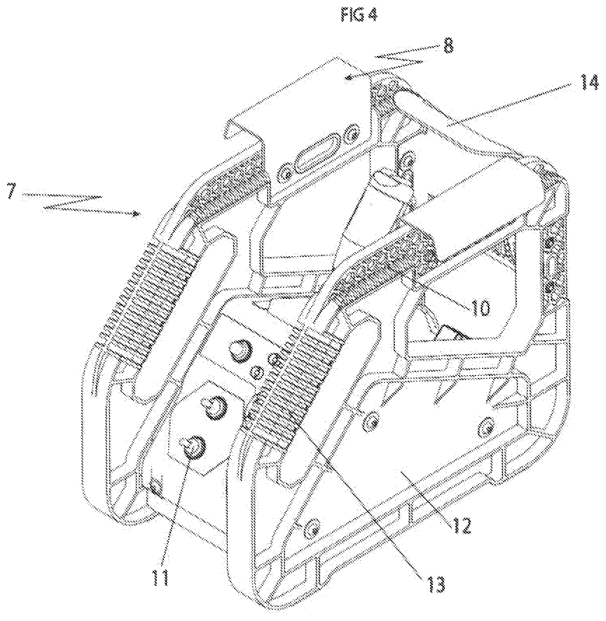

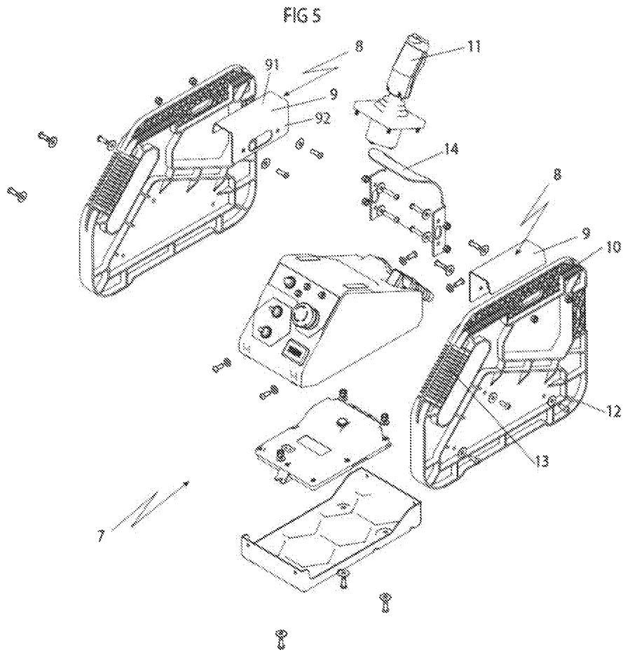

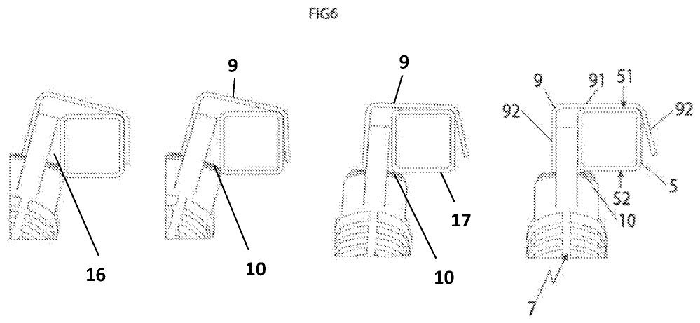

The invention will be well understood on reading the following description of exemplary embodiments, with reference to the attached drawings in which:

[FIG. 1] represents a perspective view of a lifting machine with the control console coupled to a longitudinal wall of the guard rail;

[FIG. 2] represents a perspective view of the lifting machine of FIG. 1 with the control console coupled to the opposite longitudinal wall of the guard rail;

[FIG. 3] represents a perspective view of the lifting machine with the control console uncoupled from the guard rail, the operator being to the side of the work platform and holding the control console by a lateral handle;

[FIG. 4] represents a perspective view of the control console of a lifting machine;

[FIG. 5] represents an exploded perspective view of the control console of a lifting machine showing the constituent elements;

[FIG. 6] represents, in diagram form, the steps of deformation of the fixing member with a view to a snap-fitting fixing of the control console to the top rail.

As mentioned above, the invention relates to a lifting machine 1 which can conform to that represented in FIG. 1. This lifting machine 1 comprises a chassis 15, a lifting mechanism 6 mounted on the chassis 15 and a work platform 2 mounted on the lifting mechanism 6. The chassis 15 is provided with front wheels and rear wheels through which the chassis 15 rests on the ground. These wheels make it possible to move the lifting machine on the ground. As a variant, the chassis 15 is provided with tracks for the purposes of movement on the ground.

The lifting machine 1 can have motorization to allow it to move autonomously on the ground. It can be electric or combustion motorization, even hybrid motorization. The motorization is generally mounted directly on the chassis 15.

As a variant, the lifting machine 1 has no motorization for its movement on the ground. In this case, the lifting machine is pulled or pushed to move it on the ground.

According to another variant, the chassis 15 of the lifting machine is arranged fixedly with respect to the ground either on a motor vehicle, such as a truck, without the possibility of controlling movement of the vehicle on the ground from the lifting machine 1.

As can be seen in FIG. 2, the lifting machine 1 is, here, a scissor lifting machine. The lifting mechanism 6 is therefore a scissor lifting mechanism. This type of lifting mechanism is known per se. It comprises beams that are articulated at their center in the manner of scissors. These scissor mechanisms are mounted on top of one another by their ends which are pivottingly linked in order to reach the desired working height. One or more hydraulic cylinders make it possible to extend or retract the scissor lifting mechanism 6 to raise and lower the work platform 2.

As a variant, the invention relates also to a vertical mast lifting machine 1. The vertical mast lifting machines 1 are known per se. A lifting mechanism is designed at least in the form of an extendable mast comprising vertical parts sliding on or in one another to extend vertically to the desired working height. Their lifting mechanisms sometimes comprise a turret on which the sliding vertical parts are mounted, the turret being mounted to pivot on the chassis about a vertical axis in order to be able to vary the orientation of the work platform with respect to the chassis.

The work platform is mounted on the upper vertical part, either fixedly, or through an arm articulated on the vertical mast about a horizontal axis.

More generally, the invention relates to any other type of lifting machine 1, regardless of the type of lifting mechanism 6 of the work platform 2.

The work platform 2 comprises a floor 3 formed by a deck extending horizontally when the lifting machine 1 is placed on a horizontal ground. This floor 3 makes it possible to receive one or more persons on board, and possibly equipment. It is surrounded by a guard rail 4 to prevent persons from falling out of the work platform 2.

As can be seen in FIG. 1, the guard rail 4 forms the longitudinal 41 and transverse 42 walls of an enclosure surrounding at least a part of the floor 3. This guard rail here comprises four facets each corresponding to a respective side of the platform 2. Each wall of the guard rail 4 is open and formed by a tubular structure. The guard rail 4 comprises, on each wall, a top rail 5 called hand rail and at least one intermediate rail, and a bottom rail forming a baseboard.

The rails are linked together by uprights. Rails and uprights form the constituent tubular structure of a wall. At least the top rail 5 of the guard rail 4 is a rail of non-circular cross-section. In particular, this top rail 5 is a rail of quadrangular cross-section, the corners being able to be cut, rounded or right-angled. The top rail 5 thus has a top face 51, a bottom face 52 and two lateral faces linking the top 51 and bottom 52 faces to one another.

The lifting machine 1 also comprises a control console 7 illustrated in FIG. 4. The control console 7 is equipped with one or more manually-actuated control members 11 allowing an operative to provoke the heightwise movement of the work platform 2 to reach the desired working position and to lower the latter onto the chassis 15, and, if appropriate, to provoke the movement of the lifting machine on the ground.

Generally, one of the control members 11 is a pivoting lever, also called joystick. This pivoting lever can be displaced in at least four directions (front, rear and right, left) to control in particular the lifting mechanism 6. The detail of these control members will not be provided because it is well known to those skilled in this art. Other control members, such as buttons, can also be provided.

In the example represented in FIG. 4, the control console 7 comprises two side plates 12 facing one another forming lateral side plates between which the control member or members 11 extend. Indeed, the side plates 12 are linked to one another by a bridge bearing the control members 11. Each side plate 12 has an inner face turned toward the other side plate and an opposite outer face. Each side plate is generally made of plastic material. Each side plate has a top edge and an opposite bottom edge.

In the example represented, each of the side plates 12 is provided with a lateral gripping handle 13 produced in a single piece with said side plate 12. This lateral handle 13 is formed by a through aperture formed in said side plate 12.

The control console 7 also comprises a central handle 14 disposed between the side plates 12 and coupled to each of the side plates 12. Once again, this central handle 14 is formed by a through aperture formed in an added part extending between said side plates 12.

These various handles facilitate handling of the control console 7 by the operative when the latter is situated outside of the work platform 2 and controls the lifting machine 1 from the ground as illustrated in FIG. 3. In this case, the control console 7 can be linked to the lifting machine 1 by a wired link as represented or by a wireless link.

The control console 7 also comprises a fixing device 8 to allow the control console 7 to be removably coupled to the top rail 5. In a way that is a feature of the invention, the control console 7 can be coupled to the top rail 5 by snap-fitting.

As FIGS. 1 and 2 illustrate, the control console 7 has distinct positions of coupling to the top rail 5 and is configured to switch from one coupling position to another without tools. These coupling positions can be many and various. Thus, one coupling position of the control console 7, as illustrated in FIG. 2, is a position in which the control console 7 extends at least partially inside the enclosure delimited by the guard rail 4, and one of the coupling positions of the control console 7, as illustrated in FIG. 1, is a position in which the control console 7 extends at least partially out of the enclosure delimited by the guard rail 4.

Two of the coupling positions of the control console 7 correspond, for one, to a position in which the control console 7 is coupled to one of the longitudinal 41, or respectively transverse 42, walls of the enclosure, and, for the other, to a position in which the control console 7 is coupled to the opposite longitudinal, or respectively transverse 42, wall of said enclosure. FIGS. 1 and 2 illustrate the case where the control console 7 can be coupled to two opposite longitudinal walls. Thus, the control console 7 can, without distinction, be used by a right-handed person or a left-handed person.

To allow such mounting, the fixing device 8 of the control console 7 comprises, for the control console 7 to be coupled to the top rail 5 by snap-fitting, one or more fixing members 9 that are at least partially elastically deformable.

In the examples represented, the fixing device 8 comprises several fixing members 9, these fixing members 9 being able to be activated selectively according to the selected coupling position.

Preferably, the fixing device 8 comprises at least two at least partially elastically deformable fixing members 9 disposed, for one, on one of the side plates, and for the other, on the other of the side plates 12 of the control console 7. These fixing members 9 are, here, selectively active.

At least one of the fixing members 9, here each fixing member 9, takes the form of a U-shaped spring clamp, the interior of the U forming a space for at least partially receiving the top rail 5. Indeed, each fixing member 9, when the control console 7 is coupled to the top rail 5 at least by said fixing member 9, caps the top rail 5 on the top and, the control console 7 has a surface 10 in bearing contact with the bottom face 52 of the top rail 5.

When the fixing member 9 has the form of a U-shaped spring clamp, said U having a web 91 and two branches 92, one of the branches 92 of the U is fixed to one of the side plates 12 of the control console 7 on the so-called inner face of the side plate turned toward the other side plate. The U straddles the side plate, in particular the so-called top edge of the side plate, such that the other branch 92 of the U extends on the side of the outer face opposite the inner face of the side plate. By virtue of this straddled positioning of the U on the side plate, the branches of the U extend on either side of the side plate while the web of the U extends facing the so-called top edge of the side plate. In other words, the control console 7 comprises two side plates 12 between which said control members 11 extend. Each side plate 12 bears at least one fixing member 9. Each fixing member 9 of the fixing device 8 protrudes at least partially from the side plate 12 which bears it outward from the control console 7, that is to say protruding from the outer face of the side plate, the outer face corresponding to the face of the side plate opposite the so-called inner face of the side plate turned toward the other side plate.

Each fixing member 9 has the form of a U-shaped spring clamp straddling said side plate associated with the branches 92 of the U extending, for one, on the side of the inner face of said side plate, and for the other, on the side of the outer face of the side plate and the web of the U extending facing the so-called top edge of said side plate. The branch of the U extending on the side of the inner face of the side plate is fixed to said inner face of the side plate to move integrally therewith.

The bearing surface 10 of the control console extends also on the side of the outer face of the side plate. This bearing surface 10 is, here, produced in the form of a bead or a bulge or even a shoulder disposed on the side of the outer face of the side plate. This bead extends substantially parallel to within ±20° to the top edge of the side plate.

By virtue of this embodiment, the Us are therefore open toward the floor of the work platform when the control console is fixed to the guard rail, in particular to the top rail of the guard rail.

At least a part of the bearing surface 10 and at least a part of the or of at least one of the fixing members 9 define between them a housing 16 for the top rail 5 having a passage 17 for insertion of the top rail 5 into said housing 16. This passage 17 is configured to, by elastic deformation of at least a part of the or of at least one of the fixing members 9, widen upon the introduction of the top rail 5 into said housing before closing up again beyond a predetermined position of introduction of the top rail 5 into said housing. In particular, at least a part of the bearing surface 10 and at least a part of the at least partially elastically deformable fixing member 9, in this case the branch of the U of the fixing member 9 disposed on the side of the outer face of the side plate, define the passage for insertion of the top rail into the U. This passage tends, by elastic deformation of said fixing member 9, to widen as the top rail is covered by the elastically deformable fixing member 9 before closing up again beyond a predetermined position of covering of the top rail by the fixing member 9. This mounting by snap-fitting and the elastic deformations observed are represented in FIG. 6.

When the control console 7 is coupled to the top rail, the bearing surface 10 of the control console 7, in bearing contact with the bottom surface 52 of the top rail 5, extends in a transverse, preferably orthogonal, plane, that is to say at right angles to the plane passing through one of the branches of the U and at a distance from a plane passing through the web of the U depending on the distance between the top 51 and bottom 52 faces of the top rail 5 to sandwich the top 51 and bottom 52 faces of the top rail 5 between said bearing surface 10 of the control console and the web of the U when the top rail 5 is at least partially inserted into the U. In the examples represented, the housing is of generally quadrangular section and the passage for insertion of the top rail 5 into the housing is formed in one of the corners of said housing. The passage for insertion is thus formed between at least a part of the bearing surface 10 and an end of one of the branches of the U.

This bearing surface 10 very clearly extends between two planes passing, for one, through one of the branches of the U, and for the other, through the other branch of the U formed by the fixing member 9 which has the form of a U-shaped spring clamp.

As mentioned above, the bearing surface 10 of the control console extends also on the side of the outer face of the side plate. Thus, when the control console 7 is coupled to the top rail 5, at least a part of the control console 7 extends at least partially overhanging the guard rail 4 to generate, under the effect of the weight of said overhanging part of the control console 7, a tilting torque of the control console 7, bringing the bearing surface 10 of the control console 7 closer to the bottom face 52 of the top rail 5 with which the bearing surface 10 of the control console 7 is in bearing contact.

The non-circular form of the top rail makes it possible to avoid a rotation of said control console about the top rail. The substantially flat top face 51 of the top rail 5 is covered by the web of the U of the fixing member 9 in bearing contact with said top face 51. Likewise, the bottom face 52 of the substantially flat top rail 5 cooperates perfectly with the bearing surface 10.

By virtue of this elastic deformation, the fixing of the control console 7 onto the guard rail 4 can be performed in a few seconds. It is in fact sufficient to position one of the fixing members 9 of the control console on top of the top face 51 of the top rail 5, lower said fixing member 9 by lowering the control console 7 to introduce the top rail 5 into the passage formed between the bearing surface 10 and one of the branches 92 of the U, this introduction generating an elastic deformation of the U in a direction of separation of the branches of the U, and to continue this movement until the position of introduction in which the web 91 of the U is in bearing contact with the top face of the top rail and the bearing surface 10 can come to be positioned under the bottom face 52 of the top rail 5 under the effect of the elastic return force of the branches of the U, bringing them closer to one another. In other words, the method for coupling the control console to the top rail comprises a step of introduction of the top rail 5 into the insertion passage 17 of the housing 16 defined by at least a part of the bearing surface 10 and at least a part of the or of at least one of the fixing members 9 during which the or at least one of the elastically deformable fixing members 9 is deformed in the direction of a widening of said passage 17 and a step of continuation of the introduction to a predetermined position of introduction of the top rail 5 into said housing 16 in which said passage 17 closes up again.

Elastic deformations in the reverse direction allow the control console to be easily dismantled. All it takes in fact is to act on the control console in the direction of separation of the branches of the U of the fixing member 9 to open the passage and allow the fixing member 9 to be raised. The mounting and the dismantling of the control console can therefore be performed quickly without tools, and at any location on the top rail.

1. A lifting machine (1) comprising a work platform (2), a lifting mechanism (6) for raising said work platform (2), and a control console (7) for controlling at least the lifting mechanism (6), said work platform (2) comprising a floor (3) and a guard rail (4) forming the longitudinal (41) and transverse (42) walls of an enclosure surrounding at least a part of said floor (3), said guard rail (4) comprising at least one top rail (5), called hand rail, of non-circular section, this top rail (5) having a top face (51) and a bottom face (52) and the control console (7) comprising a fixing device (8) to allow the control console (7) to be removably coupled to the top rail (5), characterized in that the control console (7) can be coupled to the top rail (5) by snap-fitting, in that the fixing device (8) of the control console (7) comprises, for the control console (7) to be coupled to the top rail by snap-fitting (5), one or more fixing members (9) that are at least partially elastically deformable and in that the control console (7) has at least one so-called bearing surface (10), that is able to come into bearing contact with the top rail (5) when the control console (7) is coupled to the top rail (5), at least a part of the bearing surface (10) and at least a part of the or of at least one of the fixing members (9) defining between them a housing (16) for the top rail (5) having a passage (17) for insertion of the top rail (5) into said housing, this passage (17) being configured to, by elastic deformation of at least a part of the or of at least one of the fixing members (9), widen upon the introduction of the top rail (5) into said housing before closing up again beyond a predetermined position of introduction of the top rail (5) into said housing.

2. The lifting machine (1) as claimed in claim 1, characterized in that the so-called bearing surface (10), able to come into bearing contact with the top rail (5) when the control console (7) is coupled to the top rail (5), is a surface, preferably rigid, configured to come at least into bearing contact with the bottom face (52) of the top rail (5).

3. The lifting machine (1) as claimed in one of claims 1 and 2, characterized in that the or at least one of the at least partially elastically deformable fixing members (9) of the fixing device (8) for fixing the control console (7) to the top rail (5) caps the top rail (5) on the top, when the control console (7) is coupled to the top rail (5).

4. The lifting machine (1) as claimed in one of claims 1 to 3, characterized in that the or at least one of the fixing members (9) which, when the control console (7) is coupled to the top rail (5), caps the top rail (5) on the top, is a U-shaped spring clamp that is open toward the floor (3) and in that at least a part of the or of at least one of the bearing surfaces (10) of the control console (7) is disposed facing the web of the U to delimit, with the U, the housing for receiving the top rail (5).

5. The lifting machine (1) as claimed in claim 4, characterized in that the housing (16) is of generally quadrangular section and the passage (17) for insertion of the top rail (5) into said housing (16) is formed in one of the corners of said housing, preferably between at least a part of the bearing surface (10) and an end of one of the branches of the U.

6. The lifting machine (1) as claimed in one of claims 4 and 5, characterized in that, when the control console (7) is coupled to the top rail (5), the part of the bearing surface (10) of the control console (7), in bearing contact with the bottom face (52) of the top rail (5) extends in a plane that is transverse, preferably orthogonal, to the plane passing through one of the branches of the U and at a distance from the web of the U according to the distance between the top (51) and bottom (52) faces of the top rail (5) to sandwich the top (51) and bottom (52) faces of the top rail (5) between said bearing surface (10) of the control console and the web of the U.

7. The lifting machine (1) as claimed in one of claims 1 to 6, characterized in that, when the control console (7) is coupled to the top rail (5), at least a part of the control console (7) extends at least partially overhanging the guard rail (4) to generate, under the effect of the weight of said overhanging part of the control console (7), a tilting torque of the control console (7), bringing the bearing surface (10) of the control console (7) closer to the bottom face (52) of the top rail (5) with which the bearing surface (10) of the control console (7) can come into bearing contact.

8. The lifting machine (1) as claimed in one of claims 1 to 7, characterized in that the control console (7) comprises at least one control member (11) and two side plates (12) between which the or at least one of the control members (11) extends and in that at least one of the fixing members (9) of the fixing device (8) protrudes at least partially from one of the side plates (12) outward from the control console (7), that is to say protruding from the outer face of the side plate (12), the outer face corresponding to the face of the side plate (12) opposite the so-called inner face of the side plate turned toward the other side plate (12).

9. The lifting machine (1) as claimed in claim 8, characterized in that the fixing device (8) comprising several fixing members (9), at least one of the fixing members (9) of the fixing device (8) protrudes at least partially from one of the side plates (12) outward from the control console (7) and at least the other or one other of the fixing members (9) of the fixing device (8) protrudes at least partially from the other of the side plates (12) outward from the control console (7), in that the control console (7) has distinct positions for coupling to the top rail (5), and in that the fixing members (9) are members that can be selectively activated according to the selected coupling position.

10. The lifting machine (1) as claimed in one of claims 8 and 9, characterized in that at least one of the side plates (12) is provided with a so-called lateral gripping handle (13) produced in a single piece with said side plate (12) and in that the control console (7) comprises a central handle (14) disposed between the side plates (12) and coupled to each of the side plates (12).

11. A method for coupling, to the top rail of a guard rail (4) of a lifting machine (1), a control console (7) used to control at least the lifting mechanism (6) of said lifting machine (1), characterized in that, said lifting machine (1) conforming to one of claims 1 to 10, the method comprises a step of introduction of the top rail (5) into the insertion passage (17) of the housing (16) defined by at least a part of the bearing surface (10) and at least a part of the or of at least one of the fixing members (9) during which the or at least one of the elastically deformable fixing members (9) is deformed in the direction of a widening of said passage (17) and a step of continuation of the introduction to a predetermined position of introduction of the top rail (5) into said housing (16) in which said passage (17) closes up again.
